(19) United States
(12) Patent Application Publication
(10) Pub. No.: US 2018/0087948 A1
(43) Pub. Date: Mar. 29, 2018

(54) APPARATUS AND METHOD TO DETECT FUEL PILFERAGES AND FUEL FILLINGS

(71) Applicant: Rivigo Services Private Limited, Gurugram (IN)

(72) Inventor: Hemant KHANDELWAL, Bangalore (IN)

(21) Appl. No.: 15/683,641

(22) Filed: Aug. 22, 2017

(30) Foreign Application Priority Data
Sep. 23, 2016 (IN) 201611032601

(51) Int. Cl. G01F 23/00; B60K 15/03

(52) U.S. Cl. CPC G01F 23/0076; G06Q 50/28; B60K 15/03

(57) ABSTRACT

The present disclosure provides a system for detection of one or more fuel pilferage events in one or more vehicles. The fuel pilferage detection system includes a first step of receiving a first set of data. In addition, the fuel pilferage detection system includes another step of collecting a second set of data. Further, the fuel pilferage detection system includes yet another step of analyzing the first set of data and the second set of data. The fuel pilferage detection system includes yet another step of categorizing the one or more vehicles in the plurality of categories based on the analyzing of first set of data and the second set of data. The fuel pilferage detection system includes yet another step of identifying the one or more fuel pilferage events in the one or more vehicles based on the analyzing of first and second set of data.

### TECHNICAL FIELD

The present disclosure relates to a field of fuel pilferage system. More specifically, the present disclosure relates to a system for dynamic and efficient detection of one or more fuel pilferage events in one or more vehicles.

### BACKGROUND

Logistics organizations rely on a fleet of vehicles for transporting packages from one place to another within a city or country. These vehicles commute for large distances and make a pit stop at several fuel filling stations for re-fueling purposes. Typically, these vehicles are equipped with one or more fuel level sensors for providing a current value of the fuel. These fuel sensors are connected to a fuel gauge of the vehicles. In addition, the fuel sensors are mostly used for indicative purposes to know when the fuel has to be filled. However, the logistics organizations face a rampant problem of fuel pilferage or fuel theft which costs the transport industry a lot of money. Typically, the driver of the vehicle who has access to every part of the vehicle is suspected to carry out the fuel pilferage or fuel theft. Currently there is no reliable technology available in the art which can accurately determine fuel pilferage or an amount of fuel pilferage. The currently available fuel sensors do not provide accurate fuel level data due to issues with sensor calibration. The fuel values are not accurate due to high fluctuations in fuel levels inside fuel tank. Further, the values are unprocessed and identification of any changes in fuel value is not proper.

### SUMMARY

In a first example a computer implemented method is provided. The computer implemented method for real time dynamic and efficient detection of one or more fuel pilferages events in one or more vehicles having one or more sensors. The computer-implemented method may include a first step of receiving a first set of data at a fuel pilferage detection system. The first set of data corresponds to fuel level values associated with one or more fuel sensors. The computer-implemented method includes another step of collecting a second set of data at the fuel pilferage detection system. The second set of data is associated with a real time position of the one or more vehicles travelling from one point to another. The computer-implemented method includes yet another step of analyzing the first set of data and the second set of data at the fuel pilferage detection system. The computer-implemented method includes yet another step of categorizing the one or more vehicles in a plurality of categories at the fuel pilferage detection system. The categorizing of the one or more vehicles in a plurality of categories is based on the analysis of first set of data and the second set of data. The computer-implemented method includes yet another step of identifying the one or more fuel pilferage events at the fuel pilferage detection system. The identification of the one or more fuel pilferage events in the one or more vehicles is based on the analysis of the first set of data and the second set of data. The first set of data is received from the one or more fuel sensors in real time. In addition, the one or more fuel sensors are installed in one or more vehicles. The second set of data is collected from the one or more geo-location sensors in real time. The one or more geo-location sensors are installed in the one or more vehicles. The analyzing is done to identify the position of the one or more vehicles, time and a current working status of the one or more fuel sensors based on real time fuel values. The plurality of categories includes a first category of vehicles in which one or more sensors are not installed. In addition, the plurality of categories includes a second category of vehicles having one or more sensors with insufficient data for categorization. Further, the plurality of categories includes a third category of vehicles having one or more non-calibrated sensors. Moreover, the plurality of categories includes a fourth category of vehicles having one or more null dropping sensors. Furthermore, the plurality of categories includes a fifth category of vehicles having one or more zero dropping sensors. Also, the plurality of categories includes a sixth category of vehicles having one or more fluctuating sensors. The plurality of categories includes a seventh category of vehicles having one or more working sensors. The categorization of one or more vehicles is done in real time. The identification is done by utilizing a fuel pilferage detection algorithm. The identification of the one or more fuel pilferage events is done for each associated current status of the one or more vehicles and the one or more sensors installed in one or more vehicles. The current status includes a running state of the one or more vehicles, a stoppage state of the one or more vehicles, a missing data state of the one or more sensors. The identification is done in real time.

In an embodiment of the present disclosure, the computer-implemented method includes yet another step of calculating a fuel confidence score to reduce one or more false positive pilferage detection events at the fuel pilferage detection system. The fuel confidence score is calculated based on one or more parameters. The one or more parameters includes auto-correlation score, drop rate, pre-rise, post rise, immediate-pre rise, immediate post rise, near-by mileage, null count and extreme fluctuation.

In an embodiment of the present disclosure, the computer-implemented method includes yet another step of storing the first set of data, the second set of data, the one or more fuel pilferage events and a fuel confidence score at the fuel pilferage detection system. The storing is done in real time.

In an embodiment of the present disclosure, the computer-implemented method includes yet another step of updating the first set of data, the second set of data, the one or more fuel pilferage events and a fuel confidence score at the fuel pilferage detection system. The updating is done in real time.

In an embodiment of the present disclosure, the computer-implemented method includes yet another step of feedback mechanism to improve a prediction accuracy of the one or more fuel pilferage events at the fuel pilferage detection system. The feedback mechanism is performed in real time.

In an embodiment of the present disclosure, the one or more vehicles are categorized in the first category of the plurality of categories when one or more actual data points collected within a fixed interval of time is zero. The one or more vehicles are categorized in the second category of the one or more vehicles when distance covered by the one or more vehicles is at most 500 in a fixed interval of time. In addition, the one or more vehicles are categorized in the second category of the one or more vehicles when one or more actual data points are at most 500 in a fixed interval of time. The fixed interval of time comprises last 7 days.

In an embodiment of the present disclosure, the one or more vehicles are categorized in the third category of the plurality of categories when a difference between a maximum fuel and minimum fuel of the one or more vehicles are at most 370. In addition, the one or more vehicles are categorized in the third category of the plurality of categories when a distance covered by the one or more vehicles in a fixed interval of time is more than a minimum distance. Further, the one or more vehicles are categorized in the third category of the plurality of categories when non-null zero data points are more than 1000. Also, the fixed interval of time comprises of last 7 days.

In an embodiment of the present disclosure, the one or more vehicles are categorized in the fourth category of the plurality of categories when null score calculated in real time is at least 20. In addition, the one or more vehicles are categorized in the fifth category of the plurality of categories when a zero score calculated in real time is at least 10.

In an embodiment of the present disclosure, the one or more vehicles are categorized in the sixth category of the plurality of categories when at least one of an autocorrelation score is less than 40 percent. The one or more vehicles are categorized in the sixth category of the plurality of categories when an extreme fluctuating score is more than 5 percent for 50 litres and 8 percent of 30 litres.

In an embodiment of the present disclosure, each vehicle of the one or more vehicles is driven from source to destination by a plurality of drivers. Each driver of the plurality of drivers is part of a driver relay system. Each driver of the plurality of drivers drives the vehicle from a first pit point to a second pit point for a fixed distance.

In a second example, a computer system is provided. The computer system may include one or more processors and a memory coupled to the one or more processors. The memory stores instructions which when executed by the one or more processors. The execution of instructions causes the one or more processors to perform a method for real time dynamic and efficient detection of one or more fuel pilferages events in one or more vehicles having one or more sensors. The method includes a first step of receiving a first set of data at a fuel pilferage detection system. The first set of data corresponds to fuel level values associated with one or more fuel sensors. The method includes another step of collecting a second set of data at the fuel pilferage detection system. The second set of data is associated with a real time position of the one or more vehicles travelling from one point to another. The method includes yet another step of analyzing the first set of data and the second set of data at the fuel pilferage detection system. The method includes yet another step of categorizing the one or more vehicles in a plurality of categories at the fuel pilferage detection system. The categorizing of the one or more vehicles in a plurality of categories is based on the analysis of first set of data and the second set of data. The method includes yet another step of identifying the one or more fuel pilferage events at the fuel pilferage detection system. The identification of the one or more fuel pilferage events in the one or more vehicles is based on the analysis of the first set of data and the second set of data. The first set of data is received from the one or more fuel sensors in real time. In addition, the one or more fuel sensors are installed in one or more vehicles. The second set of data is collected from the one or more geo-location sensors in real time. The one or more geo-location sensors are installed in the one or more vehicles. The analyzing is done to identify the position of the one or more vehicles, time and a current working status of the one or more fuel sensors based on real time fuel values. The plurality of categories includes a first category of vehicles in which one or more sensors are not installed. In addition, the plurality of categories includes a second category of vehicles having one or more sensors with insufficient data for categorization. Further, the plurality of categories includes a third category of vehicles having one or more non-calibrated sensors. Moreover, the plurality of categories includes a fourth category of vehicles having one or more null dropping sensors. Furthermore, the plurality of categories includes a fifth category of vehicles having one or more zero dropping sensors. Also, the plurality of categories includes a sixth category of vehicles having one or more fluctuating sensors. The plurality of categories includes a seventh category of vehicles having one or more working sensors. The categorization of one or more vehicles is done in real time. The identification is done by utilizing a fuel pilferage detection algorithm. The identification of the one or more fuel pilferage events is done for each associated current status of the one or more vehicles and the one or more sensors installed in one or more vehicles. The current status includes a running state of the one or more vehicles, a stoppage state of the one or more vehicles, a missing data state of the one or more sensors. The identification is done in real time.

In an embodiment of the present disclosure, the method includes yet another step of calculating a fuel confidence score to reduce one or more false positive pilferage detection events at the fuel pilferage detection system. The fuel confidence score is calculated based on one or more parameters. The one or more parameters includes auto-correlation score, drop rate, pre-rise, post rise, immediate-pre rise, immediate post rise, near-by mileage, null count and extreme fluctuation.

In an embodiment of the present disclosure, the method includes yet another step of storing the first set of data, the second set of data, the one or more fuel pilferage events and a fuel confidence score at the fuel pilferage detection system. The storing is done in real time.

In an embodiment of the present disclosure, the method includes yet another step of updating the first set of data, the second set of data, the one or more fuel pilferage events and a fuel confidence score at the fuel pilferage detection system. The updating is done in real time.

In an embodiment of the present disclosure, the method includes yet another step of feedback mechanism to improve a prediction accuracy of the one or more fuel pilferage events at the fuel pilferage detection system. The feedback mechanism is performed in real time.

In an embodiment of the present disclosure, the one or more vehicles are categorized in the first category of the plurality of categories when one or more actual data points collected within a fixed interval of time is zero. The one or more vehicles are categorized in the second category of the one or more vehicles when distance covered by the one or more vehicles is at most 500 in a fixed interval of time. In addition, the one or more vehicles are categorized in the second category of the one or more vehicles when one or more actual data points are at most 500 in a fixed interval of time. The fixed interval of time comprises last 7 days.

In an embodiment of the present disclosure, the one or more vehicles are categorized in the third category of the plurality of categories when a difference between a maximum fuel and minimum fuel of the one or more vehicles are at most 370. In addition, the one or more vehicles are categorized in the third category of the plurality of categories when a distance covered by the one or more vehicles in a fixed interval of time is more than a minimum distance. Further, the one or more vehicles are categorized in the third category of the plurality of categories when non-null zero data points are more than 1000. Also, the fixed interval of time comprises of last 7 days.

In an embodiment of the present disclosure, the one or more vehicles are categorized in the fourth category of the plurality of categories when null score calculated in real time is at least 20. In addition, the one or more vehicles are categorized in the fifth category of the plurality of categories when a zero score calculated in real time is at least 10.

In an embodiment of the present disclosure, the one or more vehicles are categorized in the sixth category of the plurality of categories when at least one of an autocorrelation score is less than 40 percent. The one or more vehicles are categorized in the sixth category of the plurality of categories when an extreme fluctuating score is more than 5 percent for 50 litres and 8 percent of 30 litres.

In an embodiment of the present disclosure, each vehicle of the one or more vehicles is driven from source to destination by a plurality of drivers. Each driver of the plurality of drivers is part of a driver relay system. Each driver of the plurality of drivers drives the vehicle from a first pit point to a second pit point for a fixed distance.

In a third example, a computer-readable storage medium is provided. The computer-readable storage medium encodes computer executable instructions that, when executed by at least one processor, performs a method. The method intelligently recommends one or more control schemes for controlling peak loading conditions and abrupt changes in energy pricing of one or more built environments associated with renewable energy sources. The method may include a first step of collection of a first set of statistical data associated with a plurality of energy consuming devices present in the one or more built environments. In addition, the method may include a second step of fetching a second set of statistical data associated with an occupancy behavior of a plurality of users present inside each of the one or more built environments. Moreover, the method may include a third step of accumulating a third set of statistical data associated with each of a plurality of energy storage and supply means. Further, the method may include a fourth step of receiving a fourth set of statistical data associated with each of a plurality of environmental sensors. Furthermore, the method may include a fifth step of gathering a fifth set of statistical data associated with each of a plurality of energy pricing models. Also, the method may include a sixth step of analyzing the first set of statistical data, the second set of statistical data, the third set of statistical data, the fourth set of statistical data and the fifth set of statistical data. In addition, the method may include a seventh step of recommending one or more control schemes to the plurality of energy consuming devices and the plurality of energy storage and supply means. The first set of statistical data may include a current operational state data associated with the plurality of energy consuming devices and a past operational state data associated with the plurality of energy consuming devices. In addition, the first set of statistical data may be collected based on a first plurality of parameters and the first set of statistical data is collected in real time. The second set of statistical data may include an energy consumption behavior of each of the plurality of users present inside the one or more built environments and an occupancy pattern of each of the plurality of users present inside the one or more built environments. The third set of statistical data may include current and historical energy storage and supply capacity data associated with the plurality of energy storage and supply means. The third set of statistical data may be accumulated based on a second plurality of parameters. The plurality of energy storage and supply means may include at least one of batteries, high speed flywheels, pumped hydro energy storage means and built environments. The third set of statistical data may be accumulated in the real time. The fourth set of statistical data may include a current and historical environmental condition data of at least one of inside and outside of the one or more built environments. The fourth set of statistical data may be received based on a third plurality of parameters. The fourth set of statistical data may be received in the real time. The fifth set of statistical data may include current and historical recordings of energy pricing state affecting the one or more built environments. The fifth set of statistical data may be gathered based on a fourth plurality of parameters. The fourth set of statistical data may be gathered in the real time. The analyzing may be done by performing one or more statistical functions to generate a plurality of statistical results. The analyzing may be done in the real time. The one or more control schemes may be recommended based on the plurality of statistical results. The one or more control schemes may include potential operational and non-operational instructions for optimizing the operating state of the plurality of energy consuming devices and improving the energy storage capacity of the plurality of energy storage and supply means.

### BRIEF DESCRIPTION OF THE FIGURES

Having thus described the invention in general terms, reference will now be made to the accompanying drawings, which are not necessarily drawn to scale, and wherein:

FIG. 1 illustrates a general overview of a logistic system, in accordance with various embodiments of the present disclosure;

FIG. 2A and FIG. 2B illustrate a general overview of a system for real time dynamic and efficient detection of one or more fuel pilferage events in one or more vehicles, in accordance with various embodiments of the present disclosure;

FIG. 3 illustrates a flow chart for real time efficient and dynamic detection of the one or more fuel pilferage events in the one or more vehicles, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

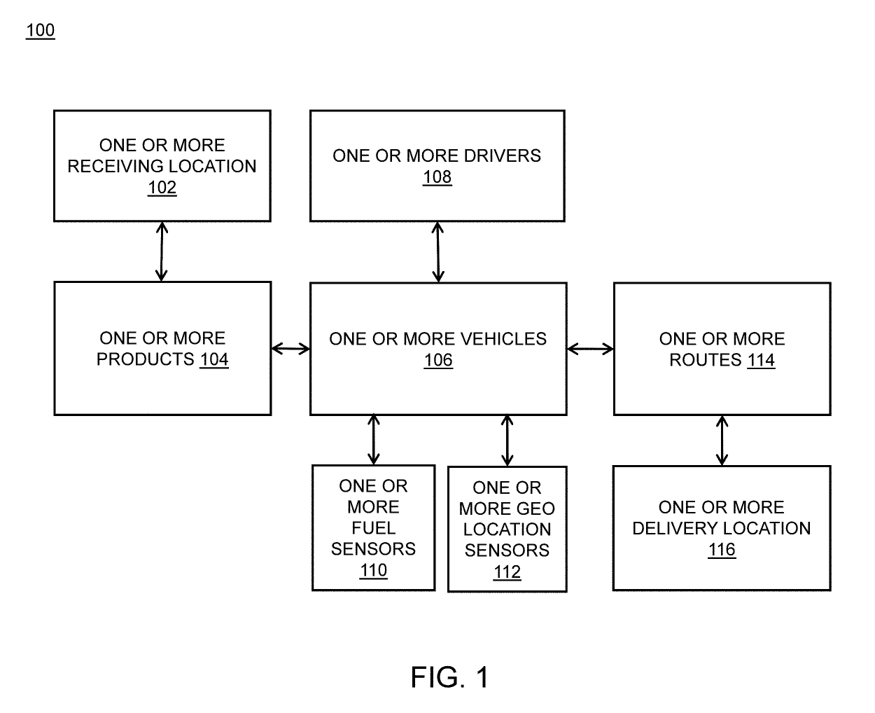

FIG. 1 illustrates a general overview of logistic system 100 for efficiently satisfying the customer requirements such as goods, services and information. The logistic system 100 includes one or more receiving location 102, one or more products 104, one or more vehicles 106, one or more drivers 108, one or more fuel sensors 110, and one or more geo location sensors 112. In addition, the logistic system 100 includes one or more routes 114 and one or more delivery location 116.

The logistic system 100 includes the one or more receiving location 102 to receive the one or more products 104. In an embodiment of the present disclosure, the one or more receiving location 102 includes manufacturing location of the one or more products 104. In another embodiment of the present disclosure, the one or more receiving location 102 includes the one or more hubs looking to transport their one or more products 104. In yet another embodiment of the present disclosure, the one or more receiving location 102 may include the place from where the one or more products 104 are need to be transported to a destination place.

In an example the one or more receiving location 102 is a Television manufacturing factory from where the LED Televisions are to be transported in bulk to different wholesaler of televisions present across the country.

The logistic system 100 includes the one or more products 104 for transportation from one place to another place. In an embodiment of the present disclosure, the one or more products 104 include goods and items which are to be transported from one place to another place. In an embodiment of the present disclosure, the one or more products 104 includes one or more electronic units such as televisions, mobile phones, washing machines, refrigerators, air conditioners, speakers and the like. In another embodiment of the present disclosure, the one or more products 104 includes one or more mechanical units such as lathe machines, mechanical tools, wheels, vehicles and the like. In another embodiment of the present disclosure, the one or more products 104 includes one or more electrical units such as cables, wires, transformers, switches, plugs, switch boards, batteries, inverters and the like. In yet another embodiment of the present disclosure, the one or more products 104 includes one or more chemical and plastic units such as buckets, oil, brush, tiffin box, cosmetics, plastic chairs and the like. In yet another embodiment of the present disclosure, the one or more products 104 includes one or more food items such as fruits, vegetables, tea, chips, juice, pulse, wheat, grain, and the like. In yet another embodiment of the present disclosure, the one or more products 104 includes one or more tangible items which have to be transported from one place to another place.

The logistics system 100 includes the one or more vehicles 106 to transport the one or more products 104 from one place to another place. In general, the one or more vehicles 106 used for transporting peoples, goods from one place to another place are of different type and size. In an embodiment of the present disclosure, the one or more vehicles 106 include the vehicles having at least four wheels such as trucks, buses, tractors, van, cars and the like. Each of the one or more vehicles 106 is different from others in shape, size, type, capacity, and strength. In an example, the one or more trucks used for the logistics system 100 are of different types and sizes with different capacities. The one or more trucks include semi-trailer truck, jumbo trailer truck, tail-lift truck, straight truck and the like. In an example, the semi-trailer truck and jumbo trailer truck have the capacity of about 24,000 kg. In another embodiment of the present disclosure, the one or more vehicles 106 include the vehicles having less than four wheels such as auto, rickshaw which are used for the transportation of a particular number of goods.

In an example, a smart phone manufacturing factory loads a large number of smart phones in a big truck to deliver the smartphones across the country. The truck unloaded the smartphones at the head office of various e-service providers after travelling a long distance. Further, the several e-service providers loaded the smartphone in one or more small vehicles such as vans, cars, and small trucks to fulfill the demand of one or more customers.

The logistic system 100 includes the one or more drivers 108 to drive the one or more vehicles 106. The one or more drivers 108 include the person or individual who know to drive the one or more vehicles 106. In an embodiment of the present disclosure, the one or more drivers 108 assigned for the logistic system 100 are the drivers having good skills and have experience in the field of driving. In an example, each of the one or more drivers 108 holding an experience of 1 year, 2 years, 5 years and the like. In an embodiment of the present disclosure, each of the one or more drivers 108 know the of their destination location. In another embodiment of the present disclosure, each of the one or more drivers 108 uses a communication device with internet connection which provides the route of their destination. In an embodiment of the present disclosure, each of the one or more drivers 108 holds the license of driving.

The logistic system 100 includes the one or more fuel sensors 110 installed in the one or more vehicles 106. The one or more fuel sensors 110 are used to measure the fuel level in the one or more vehicles 106. In addition, the one or more fuel sensors 110 are used to monitor the fuel values in the one or more vehicles 106. Further, the one or more fuel sensors 110 are used to obtain reliable information about the current fuel level in vehicle tank of the one or more vehicles 106. Moreover, the one or more fuel sensors 110 are used to detect one or more fuel pilferage events in the one or more vehicles 106. Furthermore, the one or more fuel sensors 110 are used to carry out remote tank monitoring of the one or more vehicles 106 to determine the fuel consumption. In an embodiment of the present disclosure, the one or more fuel sensors 110 are installed inside the fuel tank of the one or more vehicles 106. In another embodiment of the present disclosure, the one or more fuel sensors 110 are installed in any suitable position in the one or more vehicle 106 to measure the fuel level.

The logistic system 100 includes the one or more geo location sensors 112. The one or more geo location sensors 112 locate the position of the one or more vehicles 106 in real time. In addition, the one or more geo location sensors 112 are used to calculate a distance traveled by the one or more vehicles 106. Further, the one or more geo-location sensors 112 are used to track the positions of the one or more vehicles 106. Moreover, the one or more geo location sensors 112 are used to identify the geographic location of the one or more vehicles 106. Furthermore, the one or more geo-location sensors 112 are used to collect the information such as position and velocity of the one or more vehicles 106 in real time.

In an example, a truck is used to transport goods from Delhi to Bengaluru. The one or more geo location sensors 112 helps to track the position and velocity of the truck in real time, until the one or more driver 108 associated with the truck unload the goods at Bengaluru safely.

The logistics system 100 uses the one or more routes 114 to transport the goods from one place to another. The one or more routes 114 are the routes used by the one or more vehicles 106 for the transportation purpose. In addition, the one or more routes 114 are the paths used by the one or more vehicles 106 to transport the one or more products 104 from one place to another place. Further, the one or more routes 114 are used to connect any two places with each other. In an example the one or more routes 114 are used to connect any two cities with each other. In an embodiment of the present disclosure, the one or more routes 114 are used to connect the one or more receiving location 102 to the one or more delivery locations 116.

The logistic system 100 includes the one or more delivery locations 116 to deliver the one or more products 104. In addition, the one or more delivery locations 116 are the locations present across the country to unload the one or more products 104 received from the one or more receiving location 102. Further, the one or more delivery locations 116 are the final destination of the one or more vehicles 106 to unload the one or more products 104. In an example, the one or more delivery locations 116 may include one or more transport offices, one or more wholesalers, one or more post offices, and one or more offices of e-service providers.

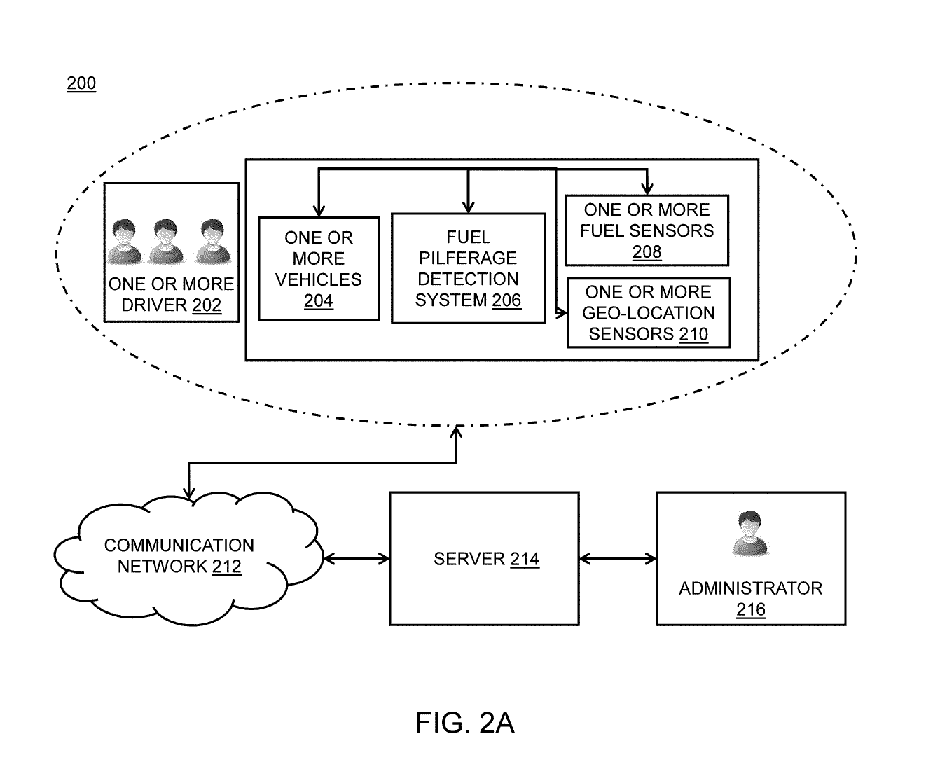

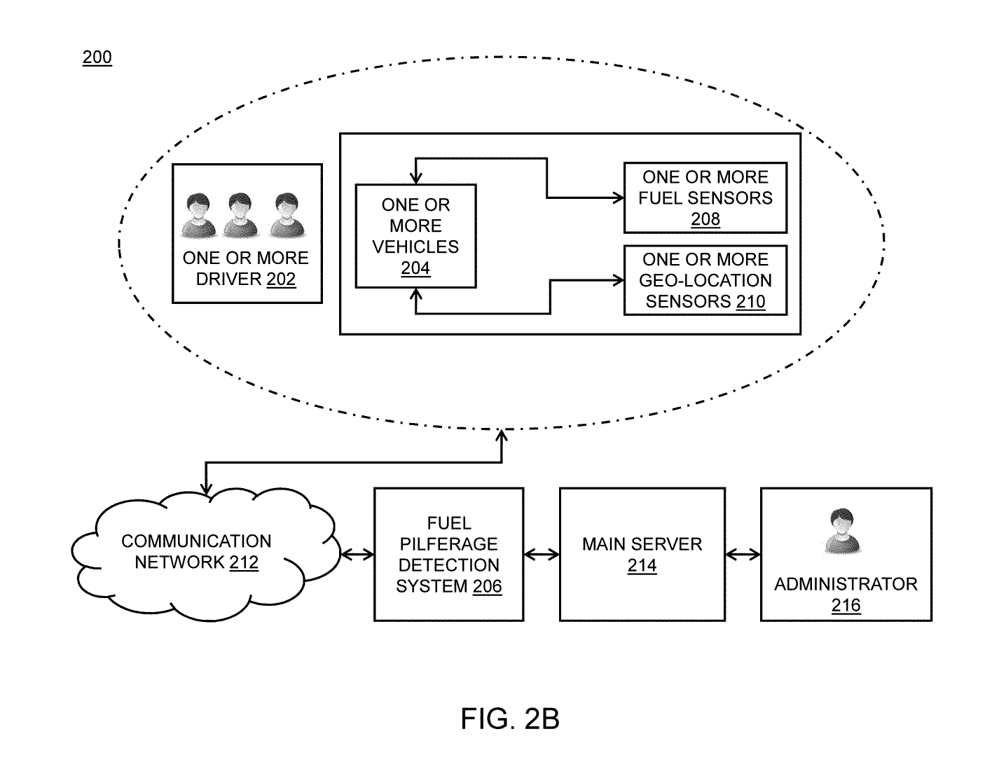

FIG. 2A and FIG. 2B illustrates a block diagram 200 of an interactive computing environment for real time detection of one or more fuel pilferage events in one or more vehicles 204, with various embodiments of the present disclosure. The interactive computing environment includes one or more drivers 202, the one or more vehicles 204, a fuel pilferage detection system 206, one or more fuel sensors 208, and one or more geo-location sensors 210. In addition, the interactive computing environment includes a communication network 212, a server 214, and an administrator 216. The above stated elements of the interactive computing environment collectively enable the detection of fuel pilferage events in the one or more vehicles 204 in the real time.

The interactive computing environment includes the one or more drivers 202 to transport the goods and products from one place to another. The one or more drivers 202 are the persons or individuals having driving skills and experience in the field of driving. In addition, the one or more drivers 202 are the drivers assigned to transport the goods from a source point to a destination point. In an embodiment of the present disclosure, each of the one or more drivers 202 is categorizes based on the skills, experience, knowledge, rating, and the like. The one or more drivers 202 are associated with the one or more vehicles 204. Each of the one or more drivers 202 holds a license of driving to drive the one or more vehicles 204.

In an example, A, B, C and D are four drivers available at transportation office to transport the goods from Delhi to Gujarat. The Driver A has an experience of 4 years, B has an experience of 5 years, C has an experience of 6 years and D has an experience of 8 years. The driver A, B and D does not have much knowledge of the route from Delhi to Gujarat, while the Driver C traveled through that route a number of times and also have knowledge of alternate routes. Based on the experience and knowledge of route, driver C has given the responsibility to transport the goods from Delhi to Gujarat.

The one or more vehicles 204 are used to transport the goods, products from one place to another place. In general, the one or more vehicles 204 used for the transportation of people, goods from one place to another place are of different type and size. In an embodiment of the present disclosure, the one or more vehicles 204 include the vehicles having at least four wheels such as trucks, buses, tractors, van, cars and the like. Each of the one or more vehicles 204 is different from others in shape, size, type, capacity, and strength. In an example, the one or more trucks used for the transportation are of different types and sizes with different capacities. The one or more trucks include semi-trailer truck, jumbo trailer truck, tail-lift truck, straight truck and the like. In an example, the semi-trailer truck and jumbo trailer truck have the capacity of about 24,000 kg. In another embodiment of the present disclosure, the one or more vehicles 204 include the vehicles having less than four wheels such as auto, rickshaw, bikes, which are used to transport a particular number of goods. In an embodiment of the present disclosure, the one or more vehicles 204 used for the transportation of heavy weight products have good strength. The storage area of each of the one or more vehicles 204 vary in length, breadth and height. Each of the one or more vehicles 204 is selected based on the quantity of goods. In an example, a small vehicle is selected when there are less number of products available for the transportation, while for the large number of products, a big vehicle with sufficient capacity is selected. The one or more vehicles 204 are associated with the fuel pilferage detection system 206.

In an embodiment of the present disclosure, each vehicle of the one or more vehicles 204 is driven from a source point to the destination point by a plurality of drivers. Each driver of the plurality of drivers is a part of the driver relay system. In general, the driver relay system is a system in which each driver of the plurality of drivers is assigned to drive the one or more vehicles 204 for a fixed distance. In addition, each driver of the plurality of driver drives the one or more vehicles 204 from one pit point to another pit point.

In an example, a vehicles loaded with goods has to cover a distance of 600 km from one place to another place. The driver present at a first pit point drives the vehicle for first 200 kilometer to reach at a second pit point. In addition, another driver present at the second pit point drives the same vehicles for next 200 kilometer to reach at a third pit point. Further, the next 200 km is covered by another driver present at the third pit point to reach at the final destination.

The fuel pilferage detection system 206 is used to detect the one more fuel pilferage events in the one or more vehicles 204 using one or more sensors. The one or more fuel pilferage events are detected in real time when the one or more vehicles 204 transport goods or products from one place to another place. The fuel pilferage detection system 206 is installed in the one or more vehicles 204 for real time dynamic and efficient detection of the one or more fuel pilferage events.

The fuel pilferage detection system 206 includes the one or more fuel sensors 208 to measure the fuel level values in the one or more vehicles 204. In addition, the one or more fuel sensors 208 are used to monitor the fuel level values in the one or more vehicles 204. Further, the one or more fuel sensors 208 are used to obtain reliable information about the current fuel level in fuel tank of the one or more vehicles 204. Moreover, the one or more fuel sensors 208 are used to detect the one or more fuel pilferage events in the one or more vehicles 204. Furthermore, the one or more fuel sensors 208 are used to carry out remote tank monitoring of the one or more vehicles 204 to determine the fuel consumption. In an embodiment of the present disclosure, the one or more fuel sensors 208 are fixed inside the fuel tank of the one or more vehicles 204. In another embodiment of the present disclosure, the one or more fuel sensors 208 installed in any suitable position in the one or more vehicles 204 to measure the fuel level values. In an embodiment of the present disclosure, the length of each of the one or more fuel sensors 208 is cut to fix the one or more fuel sensors 208 in different size fuel tanks of the one or more vehicles 204.

The fuel pilferage detection system 206 includes the one or more geo location sensors 210 to locate the position of the one or more vehicles 204 in real time. In addition, the one or more geo location sensors 210 are used to calculate a distance traveled by the one or more vehicles 204. Further, the one or more geo location sensors 210 are used to track the positions of the one or more vehicles 204. Moreover, the one or more geo location sensors 210 are used to identify the geographic location of the one or more vehicles 204. Furthermore, the one or more geo-location sensors 210 are used to collect the information such as position and velocity of the one or more vehicles 204 in real time. In an embodiment of the present disclosure, the one or more geo location sensors 210 are fixed in the cabin of the one or more vehicles 204. In another embodiment of the present disclosure, the one or more geo location sensors 210 are fixed in any suitable position in the one or more vehicles 204. In general, the one or more geo location sensors 210 are receivers with antennas, which use a satellite based navigation system having a network of 24 satellites to provide position and velocity related information in real time. In an embodiment of the present disclosure, the one or more geo location sensors 210 allow the viewer to collect the position and velocity related information on electronic maps associated with the communication network 212.

The fuel pilferage detection system 206 collects the data from the one or more sensors. The one or more sensors include the one or more fuel sensors 208 and the one or more geo location sensors 210.

The fuel pilferage detection system 206 receives a first set of data corresponding to fuel level values. The fuel level values are associated with one or more fuel sensors 208. The first set of data is received from the one or more fuel sensors in real time. In an embodiment of the present disclosure, the first set of data includes the fuel level values, maximum fuel level values, minimum fuel level values and fuel consumption values. In another embodiment of the present disclosure, the first set of data includes all the fuel related data of the one or more vehicles used to detect the one or more pilferage events.

The fuel pilferage detection system 206 collects a second set of data. The second set of data is associated with a real time position of the one or more vehicles 204 travelling from one point to another point. The second set of data is collected from the one or more geo-location sensors 210 in real time. In addition, the one or more geo-location sensors are installed in the one or more vehicles 204. In an embodiment of the present disclosure, the second set of data includes position, velocity and time related information of the one or more vehicles 204. In another embodiment of the present disclosure, the second set of data includes all the information required to track the one or more vehicles 204. In addition, the fuel pilferage detection system 206 analyzes the first set of data and the second set of data. In addition, the analyzing of the first set of data and the second set of data is done to identify a position of the one or more vehicles 204. Further, the fuel pilferage detection system 206 analyzes the first set of data and the second set of data to identify the time and current working status of the one or more fuel sensors 208 based on real time. The fuel pilferage detection system 206 categorizes the one or more vehicles 204 in a plurality of categories based on the analysis of the first set of data and the second set of data. In addition, the fuel pilferage detection system 206 identifies the one or more fuel pilferage events in the one or more vehicles 204 based on the analysis of the first set of data and the second set of data. Further, the identification of the one or more fuel pilferage events is done by utilizing a fuel pilferage detection algorithm. The fuel pilferage detection system 206 is associated with the server 214 through the communication network 212.

In an embodiment of the present disclosure, the communication network 212 enables the fuel pilferage detection system 206 to gain access to the internet for transmitting data to the server 214. Moreover, the communication network 212 provides a medium to transfer the data between the fuel pilferage detection system 206 and the server 214. Further, the medium for communication may be infrared, microwave, radio frequency (RF) and the like.

In an embodiment of the present disclosure, the fuel pilferage detection system 206 is located in the server 214. In another embodiment of the present disclosure, the fuel pilferage detection system 206 is located in any portable communication device. The server 214 handles each operation and task performed by the fuel pilferage detection system 206. The server 214 stores one or more instructions for performing the various operations of the fuel pilferage detection system 206. The fuel pilferage detection system 206 is associated with the administrator 216. The administrator 216 is any person or individual who monitors the working of the fuel pilferage detection system 206 in real time. In an embodiment of the present disclosure, the administrator 216 monitors the working of the fuel pilferage detection system 206 through a portable communication device. The portable communication device includes a laptop, a desktop computer, a tablet, a personal digital assistant and the like.

In an embodiment of the present disclosure, the fuel pilferage detection system 206 categorize the one or more vehicles 204 in a plurality of categories based on the data received by the one or more fuel sensors 208. The plurality of categories includes a first category of vehicles having one or more sensors not being installed, a second category of vehicles having one or more sensors with insufficient data for categorization. In addition, the plurality of categories includes a third category of vehicles having one or more non-calibrated sensors, a fourth category of vehicles having one or more null dropping sensors. Further, the plurality of categories includes a fifth category of sensors having one or more zero dropping sensors, a sixth category of vehicles having one or more fluctuating sensors. Moreover, the plurality of categories includes and a seventh category of vehicles having one or more working sensors. The categorization of the one or more vehicles is done in real time.

In an embodiment of the present disclosure, the one or more not installed sensors are the one or more fuel sensors 208 which may not installed in the one or more vehicles 204. In addition, the data related to the fuel level in the form of fuel values is never received from such one or more fuel sensors 208. Further, one or more criteria are used to determine the current status of the one or more vehicles 204 in which the one or more sensors may installed or not installed. The one or more criteria include the actual data point collected in last 7 days and previous status of the one or more vehicles 204. When the actual data point is 0, the one or more vehicles 204 categorizes in the first category of vehicles in which the one or more sensors cannot be installed.

In an embodiment of the present disclosure, the one or more vehicles 204 are categorize as the vehicles with one or more insufficient data sensors. The data received by such one or more sensors in the last 7 days is not sufficient to categorize the one or more vehicles 204. The one or more criteria used to determine whether the data received by the one or more sensors is sufficient or insufficient include the distance and actual data points collected in the last 7 days. When the distance and actual data points collected by the one or more sensors is less than 500, the one or more vehicles 204 are categorize in the second category of vehicles with one or more insufficient data sensors.

In an embodiment of the present disclosure, the one or more vehicles 204 are categorize in the third category of vehicles with one or more non-calibrated sensors. The fuel values collected by the one or more fuel sensors 208 are not proper and do not go beyond a specific range. In an example, the specific range includes 0 to 350. The one or more criteria used to determine whether the one or more fuel sensors 208 are calibrated or non-calibrated include maximum and minimum fuel values, distance and non-null non zero data points collected in the last 7 days. When the difference between the maximum fuel values and the minimum fuel values is less than 370, the distance calculated is greater than minimum distance and the non-null zero data points is more than 1000, the one or more sensors classified as not calibrated. The minimum distance includes 1800 for 22 feet, 1500 for 22 feet reefer, 1200 for 32 feet and 1000 for 32 feet reefer.

In an embodiment of the present disclosure, the one or more vehicles 204 are categorizes in the fourth category of vehicles with one or more null dropping sensors. In an embodiment of the present disclosure, the fuel values collected by the one or more fuel sensors 208 are null, while the other one or more sensors continuously provide speed, position and time related data. In an embodiment of the present disclosure, the null dropping may be due to loose wiring or improper installation. The one or more criteria used to categorize the one or more vehicles 204 with null dropping sensors include the null score calculated in real time. When the null score calculated in the real time is more than 20, the one or more vehicles 204 identified as vehicles with one or more null dropping sensors.

In an embodiment of the present disclosure, the one or more vehicles 204 are categorizes in the fifth category of vehicle with zero dropping sensors. The fuel values collected by the one or more fuel sensors 208 are zero, while the other one or more sensors continuously provide speed, position and time related data. The one or more criteria used to categorize the one or more vehicles 204 with one or more zero dropping sensors include the zero score calculated in real time. When the zero score calculated in the real time is more than 10, the one or more vehicle 204 categorizes in the fifth category of vehicles with one or more zero dropping sensors.

In an embodiment of the present disclosure, the one or more vehicles 204 categorizes in sixth category of vehicles with one or more fluctuating sensors. The one or more vehicles 204 categorize based on the fluctuating score collected by the one or more sensors. In general, the one or more vehicles 204 have high fluctuation in the amount of fuel level when move from one place to another place. The criteria used to measure the fluctuation score of the one or more vehicles 204 include Auto-correlation score (hereinafter as “ACR”) and Extreme fluctuation percentage. In an embodiment of the present disclosure, when the auto-correlation score is less than 40 percent, the one or more vehicles 204 are categorize as vehicles with one or more fluctuating sensors. In another embodiment of the present disclosure, when the extreme fluctuating score is more than 5 percent for 50 liters and 8 percent of 30 liters, the one or more vehicles 204 categorizes in sixth category of vehicles with one or more fluctuating sensors.

In an embodiment of the present disclosure, the auto-correlation score is a correlation of the fuel values with itself using different lags. In general, the auto-correlation is the correlation of a series with itself at different points in time (lags). Further, the analysis of auto-correlation is a mathematical tool used to find the repeating patterns, analyze functions or series of values. The mathematical formula used to find the auto-correlation score is R(s,t)=[E] [(Xₜ-μₜ)(Xs-μₛ)]/(σₜ σₛ). In an embodiment of the present disclosure, the auto-correlation occurs in time-series studies when the errors associated with a given time period carry over into future time periods. In an example, while predicting the growth of stock dividends, an overestimate in one year is likely to lead overestimates in succeeding years. Further, the auto-correlation score is tested at multiple lags. In an example the multiple lags include lag1, lag2, lag3, and lag4. The final score is calculated by taking the average of lag1, lag2, lag3 and lag4. In an embodiment of the present disclosure, when the time interval between the successive observations is in minutes, hours or days, the data exhibit inter-correlation. The fuel values decreases for most successive time intervals and increases in case of filling. Moreover, a plurality of tests is done to detect the autocorrelation score. In an example, the plurality of tests includes Durbin test, Watson test and the like.

The extreme fluctuation percentage is one of the criteria used to measure the fluctuations score of the one or more fuel sensors 208 in the one or more vehicles 204. In an embodiment of the present disclosure, the points where the difference between the two subsequent fuel values is more than a threshold values are considered as extreme fluctuating points. In addition, the percentage 30 liters and the percentage 50 liters fluctuations are used to calculate the fluctuating score.

In an embodiment of the present disclosure, the one or more vehicles 204 categorize in the seventh category of vehicles with one or more working sensors. The one or more sensors which provide all the information required to detect the one or more pilferage events and work with more accuracy are categorizes as working sensors. In an example, the fuel level decreases from 500 liters to 170 liters in a regular pattern, when the vehicle A travels for a day. The continuous decrease and increase of fuel level in a regular pattern helps to decide the status of sensors. In an embodiment of the present disclosure, the output of the fuel level is analyses with the help of a fuel-speed graph. In another embodiment of the present disclosure, the output of the fuel level is analyzed with the help of other methods and techniques.

The fuel pilferage detection system 206 identifies the one or more fuel pilferage events in the one or more vehicles 204 by using one or more sensors. In addition, the identification of the one or more pilferage events is done by utilizing the fuel pilferage detection algorithm. Further, the identification of the one or more fuel pilferage events is done for each associated current status of the one or more vehicles 204. The current status of the one or more vehicles 204 include a running state of the one or more vehicles 204, a stoppage state of the one or more vehicles 204 and a missing data state of the one or more sensors.

The current status of the one or more vehicles 204 includes the stoppage zone state of the one or more vehicles 204. The stoppage zone state is the state of the one or more vehicles 204 when the one or more fuel pilferage events occur. The stoppage zone state is the state when the one or more vehicles 204 are in stationary position. In addition, the stationary position is the position of the one or more vehicles 204 at zero speed. The position and speed of the one or more vehicles 204 is collected from the one or more geo-location sensors 210 fixed in the one or more vehicles 204. In an embodiment of the present disclosure, the one or more drivers 202 associated with the one or more vehicles 204 may involve in the one or more fuel pilferage events, when the one or more vehicles 204 is in stoppage zone state. The fuel pilferage detection system 206 calculates in values when the one or more vehicles 204 are in stoppage zone state. The calculation of in-values is used to detect the one or more pilferage events. In addition, the in values calculation is used to determine the exact time and location of the one or more pilferage events. The time and location of the fuel pilferage events is identified by the one or more geo-locations sensors 210. The detection of the one or more fuel pilferage events on the basis of exact time and location helps to take a specific action. In addition, the calculation of the in-values is based on the continuous drop of the fuel values. Moreover, a threshold value is determined based on the continuous drop of the fuel level in particular interval of time. The one or more events are marked passing the threshold value to detect the one or more pilferage events.

In an example, a vehicle D is in stationary position. The initial level of fuel in the vehicle D at stationary position is observed as 400 liters. The plurality of readings is observed in successive 4 hours. The plurality of readings (in liters) includes 400, 399, 400, 401, 398, 401, 400, 396, 395, 395.5, 382, 381, 380, 382 and 381. For a particular interval of time, it was observed that the level of fuel continuously decreases from 400 to 380. The continuous drop of 20 liters of fuel in a fixed interval of time helps to detect the exact time and location of the one or more fuel pilferage events.

In an embodiment of the present disclosure, the start and end points of the one or more detected pilferage events checked again for the detection of false pilferage events. While observing the one or more pilferage events, a sharp drop is observed in the fuel level of the one or more vehicles 204 instead of a continuous drop. In an embodiment of the present disclosure, the sharp drop in the fuel level corresponds to the fluctuation in the fuel tank of the one or more vehicles 204. The fluctuation in the fuel tank of the one or more vehicles 204 may be detected as a pilferage event. The one or more events having such sharp drops need to be remove to detect one or more accurate pilferage events. In another embodiment of the present disclosure, the sharp drop in the fuel level of the one or more vehicles 204 corresponds to one or more pilferage events.

The current status of the one or more vehicles 204 includes the missing data state of the one or more sensors. The missing data state corresponds to the state when the one or more sensors are disconnected. Further, the missing data state corresponds to the state where the difference between successive data points is found to be more than 30 minutes. The one or more criteria are used to identify the one or more pilferage events when the one or more sensors installed in the one or more vehicles 204 are disconnected. The one or more criteria include delta fuel, ideal fuel consumption and threshold consumption. When the value of the delta fuel is more than the value of threshold consumption and the difference between the delta fuel value and ideal consumption value is more than 7, the one or more fuel pilferage event are detected.

The delta fuel is the difference between the start fuel level and end fuel level. In addition, the delta distance is the actual zone distance for which the one or more sensors are disconnected. The ideal consumption is the consumption of fuel which has to be during the missing zone. The threshold consumption is the threshold value of the level of fuel, above which the event identifies as pilferage events.
Delta fuel=start fuel−end fuel
Delta distance=zone distance
Ideal consumption=ideal mileage/delta distance
Threshold consumption=ideal consumption*2

In an example, a plurality of initial readings corresponding to fuel levels was observed before the disconnection of the one or more sensors. The plurality of initial readings includes 401, 400, 402, and 401. The speed and time corresponding to the plurality of initial readings includes 0, 0, 10, 20 and 8:27, 8:28, 8:29, 8:30 respectively. Further, the plurality of final readings corresponding to fuel levels was observed after reconnection of the one or more sensors. The plurality of final readings includes 381, 380, 382 and 383. The speed and time corresponding to the plurality of final readings includes 15, 8, 25, 30 and 9:30, 9:31, 9:32, 9:33 respectively. The difference observed in the fuel level reading before and after the disconnection of the one or more sensors is of 20 liters. The distance observed during the disconnection of the one or more sensors was found to be 40 kilometers. The ideal consumption of the fuel which have to be consumed is calculated as 40/5=8 liters. The threshold consumption of the fuel is calculated as 2*8=16 liters. The actual consumption of the fuel which was found during missing zone is 20 liters. The difference between the actual consumption and the ideal consumption was calculated as 20−8=12 which is more than 7. Also, the actual fuel consumption is more than the threshold consumption. The one or more criteria used to identify the pilferage event in missing zone are being satisfied. Thus the fuel pilferage event occurs during the disconnection of the one or more sensors.

The current status of the one or more vehicles 204 includes the running state of the one or more vehicles 204. The running state of the one or more vehicles 204 corresponds to the moving state of the one or more vehicles 204. The one or more fuel pilferage events are detected in between the routes, when the one or more vehicles 204 move from one location to another location. The one or more fuel pilferage events are detected based on the one or more parameters. The one or more parameters include trip, driver and route associated with the one or more vehicles 204. Further, the analysis of data related to the real fuel consumption and the estimated fuel consumption is used to detect the one or more pilferage events at the time of running state of the one or more vehicles 204.

The one or more models are used to remove the one or more false positive events. The one or more models increase the accuracy for detecting the one or more fuel pilferage events. The one or more models are used to generate a pilferage score. In addition, the pilferage score is generated to reduce the false positives events. Further, the false positive events are the events in which non-pilferage events are detect as a pilferage event. In an example, the non-pilferage event due to the fluctuation of fuel in the fuel tank of the one or more vehicles 204 may be detected as a pilferage event. The one or more model includes fuel pilferage confidence model, data science model and the like. The fuel pilferage confidence model generates the pilferage score based on the one or more parameters. The one or more parameters include auto-correlation score, drop rate, pre-rise, post-rise, immediate-pre rise, immediate post rise, near-by mileage, null count and extreme fluctuation. The pilferage score is generated by using one or more mathematical formula. The one or more mathematical formula is given by

Log [(p_{pilferage})/(1−p_{pilferage})]=β₀+β₁*AutocorrelationScore+β₂*Droprate+β₃*Prerise+β₄*Postrise+β₅*ImmediatePreRise+β₆*ImmediatePostRise+ . . . .

The autocorrelation score is the correlation of a series with itself at different points in time or lags. The one or more variable of autocorrelation score are used to give weightage to the quality of sensors. The drop rate is the rate at which the level of fuel of the one or more vehicles 204 reduced from initial fuel level to final fuel level during the pilferage event. In addition, the pre rise or immediate pre rise is used to check the random rise in the fuel level before the pilferage event. In an embodiment of the present disclosure, the random rise in the fuel level is due to the high speed of the one or more vehicles 204. Further, the post rise or immediate post rise are used to check any random rise in the fuel level after the end of the pilferage event. Moreover, the nearby mileage is used to estimate the mileage of the one or more vehicles 204 before and after 2 hours from the pilferage event. Furthermore, the null count is used to count the null values before and after 5 hours from the pilferage event. The extreme fluctuation is used to count the fluctuation in the fuel level before and after 5 hours from the pilferage event.

The data science model uses a logistic regression to calculate the pilferage score. The logistic regression is used to measure the relationship between the dependent variable and one or more independent variable by estimating probabilities. In addition, the logistic regression uses a logistic function for estimating probabilities. The logistic function is denoted by F(x).

F(x)=1/1+e^{-(β}^{₀}^{+β}^{₁}^{x)}

In an example, the “logit” model is used to solve one or more problems. The one or more problems include In [p/(1−p)]=α+βX+e. The probability of occurring of event Y is denoted by p(Y=1). In addition, In [p/(1−p)] is the log odds ratio where [p/(1−p)] is “odd ratio”.

In an embodiment of the present disclosure, the fuel pilferage detection system 206 includes a feedback loop mechanism. The feedback loop mechanism is used to improve the prediction accuracy of the fuel pilferage detection system 206. In addition, the feedback loop mechanism reduces the occurrence of false positive events.

In an embodiment of the present disclosure, the fuel pilferage detection system 206 stores the first set of data and the second set of data. In an example, the first set of data and second set of data include but may not be limited to fuel level values, the one or more fuel pilferage events, a fuel confidence score, position of the one or more vehicles 204. In another embodiment of the present disclosure, the fuel pilferage detection system 206 stores all the data used for the detection of the one or more fuel pilferage events. The fuel pilferage detection system 206 stores the data in real time.

In an embodiment of the present disclosure, the fuel pilferage detection system 206 updates the first set of data and the second set of data collected by the one or more sensors. In an example, the first set of data and the second set of data include but may not be limited to fuel level values, the one or more fuel pilferage events, a fuel confidence score, position of the one or more vehicles 204. In another embodiment of the present disclosure, the fuel pilferage detection system 206 updates all the data used for the detection of the one or more fuel pilferage events. The fuel pilferage detection system 206 updates the data in real time.

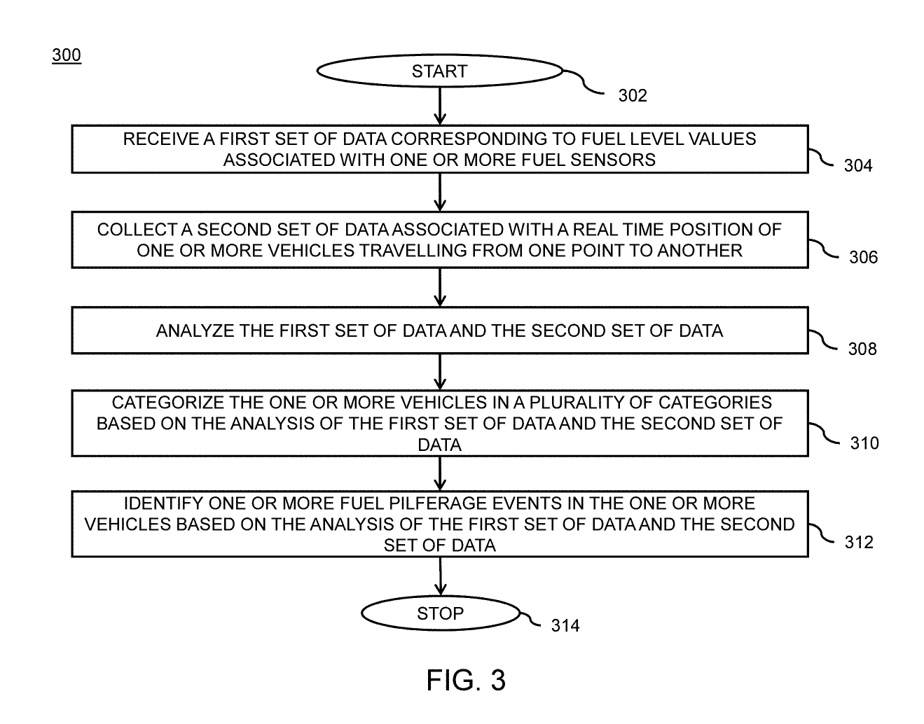

FIG. 3 illustrates a flow chart 300 for real time dynamic and efficient detection of the one or more pilferage events in the one or more vehicles, in accordance with various embodiments of the present disclosure. It may be noted that to explain the process steps of flowchart 300, references will be made to the system elements of FIG. 1, FIG. 2A and FIG. 2B. It may also be noted that the flowchart 300 may have lesser or more number of steps.

The flowchart 300 initiates at step 302. Following step 302, at step 304, the fuel pilferage detection system 206 receive the first set of data corresponding to fuel level values associated with one or more fuel sensors. At step 306, the pilferage detection system 206 collects the second set of data associated with a real time position of the one or more vehicles travelling from one point to another. At step 308, the fuel pilferage detection system 206 analyzes the first set of data and the second set of data. At step 310, the fuel pilferage detection system 206 categorize the one or more vehicles in a plurality of categories based on the analysis of the first set of data and the second set of data. At step 312, the fuel pilferage detection system 206 identify the one or more fuel pilferage events in the one or more vehicles based on the analysis of the first set of data and the second set of data. The flow chart 300 terminates at step 314.

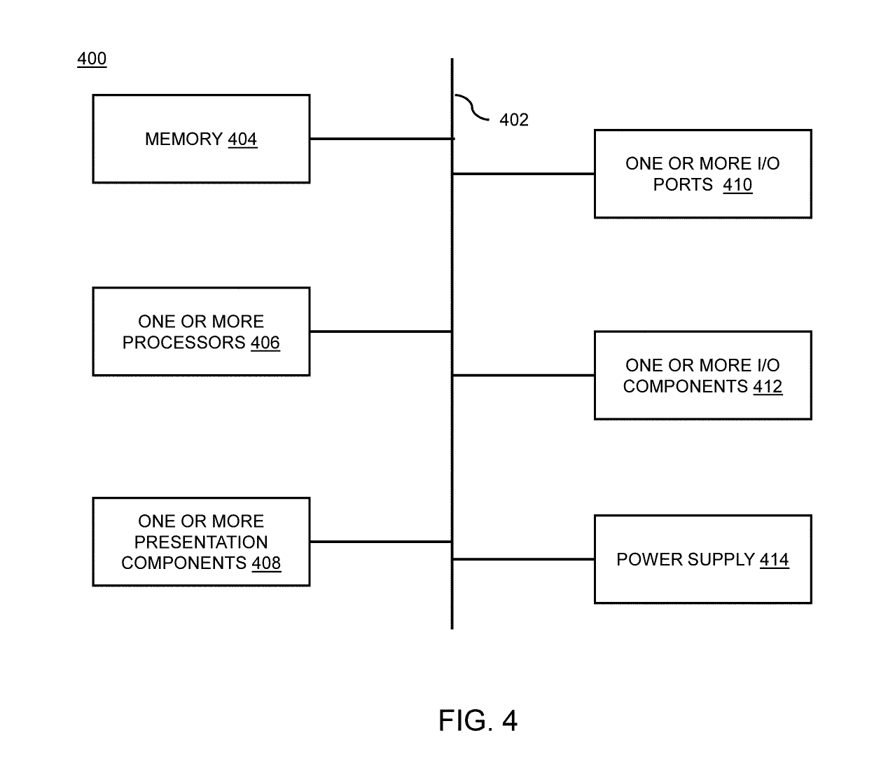

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from various entities such as memory 404 or I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A computer-implemented method for real time dynamic and efficient detection of one or more fuel pilferage events in one or more vehicles, the one or more vehicles having one or more sensors, the computer-implemented method comprising:
receiving, at a fuel pilferage detection system with a processor, a first set of data corresponding to fuel level values associated with one or more fuel sensors, wherein the first set of data being received from the one or more fuel sensors in real time and wherein the one or more fuel sensors being installed in the one or more vehicles;
collecting, at the fuel pilferage detection system with the processor, a second set of data associated with a real time position of the one or more vehicles travelling from one point to another, wherein the second set of data being collected from one or more geo-location sensors in real time and wherein the one or more geo-location sensors being installed in the one or more vehicles;
analyzing, at the fuel pilferage detection system with the processor, the first set of data and the second set of data, wherein the analyzing being done to identify a position of the one or more vehicles, time and a current working status of the one or more fuel sensors based on real time fuel level values in real time;
categorizing, at the fuel pilferage detection system with the processor, the one or more vehicles in a plurality of categories based on the analysis of the first set of data and the second set of data, wherein the plurality of categories comprises a first category of vehicles having one or more sensors not being installed, a second category of vehicles having one or more sensors with insufficient data for categorization, a third category of vehicles having one or more non-calibrated sensors, a fourth category of vehicles having one or more null dropping sensors, a fifth category of sensors having one or more zero dropping sensors, a sixth category of vehicles having one or more fluctuating sensors and a seventh category of vehicles having one or more working sensors and wherein the categorizing being done in real time; and
identifying, at the fuel pilferage detection system with the processor, the one or more fuel pilferage events in the one or more vehicles based on the analysis of the first set of data and the second set of data, wherein the identifying being done by utilizing a fuel pilferage detection algorithm, wherein the identifying of the one or more fuel pilferage events being done for each associated current status of the one or more vehicles and the one or more sensors installed in the one or more vehicles, wherein the current status comprises a running state of the one or more vehicles, a stoppage state of the one or more vehicles, a missing data state of the one or more sensors and wherein the identifying being done in real time.

2. The computer-implemented method as recited in claim 1, further comprising calculating, at the fuel pilferage detection system with the processor, a fuel confidence score to reduce one or more false positive pilferage detection events, wherein the fuel confidence score being calculated based on one or more parameters, and wherein the one or more parameters comprises auto-correlation score, drop rate, pre-rise, post-rise, immediate-pre rise, immediate-post rise, near-by-mileage, null count and extreme fluctuation.

3. The computer-implemented method as recited in claim 1, further comprising storing, at the fuel pilferage detection system with the processor, the first set of data, the second set of data, the one or more fuel pilferage events and a fuel confidence score and wherein the storing being done in real time.

4. The computer-implemented method as recited in claim 1, further comprising updating, at the fuel pilferage detection system with the processor, the first set of data, the second set of data, the one or more fuel pilferage events and a fuel confidence score and wherein the updating being done in real time.

5. The computer-implemented method as recited in claim 1, further comprising a feedback mechanism, at the fuel pilferage detection system with the processor, to improve a prediction accuracy of the one or more fuel pilferage events and wherein the feedback mechanism being performed in real time.

6. The computer-implemented method as recited in claim 1, wherein the one or more vehicles being categorized in the first category of the plurality of categories when one or more actual data points collected being zero within a fixed interval of time, wherein the one or more vehicles being categorized in the second category of the one or more vehicles when distance covered by the one or more vehicles being at most 500 in a fixed interval of time and when one or more actual data points being at most 500 in a fixed interval of time, wherein the fixed interval of time comprises last 7 days.

7. The computer-implemented method as recited in claim 1, wherein the one or more vehicles being categorized in the third category of the plurality of categories when a difference between a maximum fuel and minimum fuel of the one or more vehicles in a fixed interval of time being at most 370, when a distance covered by the one or more vehicles in a fixed interval of time being more than a minimum distance and when non-null zero data points being more than 1000 and wherein the fixed interval of time comprises of 7 days.

8. The computer-implemented method as recited in claim 1, wherein the one or more vehicles being categorized in the fourth category of the plurality of categories when null score calculated in real time being at least 20, wherein the one or more vehicles being categorized in the fifth category of the plurality of categories when a zero score calculated in real time being at least 10.

9. The computer-implemented method as recited in claim 1, wherein the one or more vehicles being categorized in the sixth category of the plurality of categories when at least one of an autocorrelation score being less than 40 percent and an extreme fluctuating score being more than 5 percent for 50 litres and 8 percent of 30 litres.

10. The computer-implemented method as recited in claim 1, wherein each vehicle of the one or more vehicles being driven from source to destination by a plurality of drivers, wherein each driver of the plurality of drivers being part of a driver relay system, wherein each driver of the plurality of drivers drives the vehicle from a first pit point to a second pit point for a fixed distance.

11. A computer system comprising:
one or more processors; and
a memory coupled to the one or more processors, the memory for storing instructions which, when executed by the one or more processors, cause the one or more processors to perform a method for real time dynamic and efficient detection of one or more fuel pilferage events in one or more vehicles, the method comprising:
receiving, at a fuel pilferage detection system, a first set of data corresponding to fuel level values associated with one or more fuel sensors, wherein the first set of data being received from the one or more fuel sensors in real time and wherein the one or more fuel sensors being installed in the one or more vehicles;
collecting, at the fuel pilferage detection system, a second set of data associated with a real time position of the one or more vehicles travelling from one point to another, wherein the second set of data being collected from one or more geo-location sensors in real time and wherein the one or more geo-location sensors being installed in the one or more vehicles;
analyzing, at the fuel pilferage detection system, the first set of data and the second set of data, wherein the analyzing being done to identify a position of the one or more vehicles, time and a current working status of the one or more fuel sensors based on real time fuel level values in real time;
categorizing, at the fuel pilferage detection system, the one or more vehicles in a plurality of categories based on the analysis of the first set of data and the second set of data, wherein the plurality of categories comprises a first category of vehicles having one or more sensors not being installed, a second category of vehicles having one or more sensors with insufficient data for categorization, a third category of vehicles having one or more non-calibrated sensors, a fourth category of vehicles having one or more null dropping sensors, a fifth category of sensors having one or more zero dropping sensors, a sixth category of vehicles having one or more fluctuating sensors and a seventh category of vehicles having one or more working sensors and wherein the categorizing being done in real time; and
identifying, at the fuel pilferage detection system, the one or more fuel pilferage events in the one or more vehicles based on the analysis of the first set of data and the second set of data, wherein the identifying being done by utilizing a fuel pilferage detection algorithm, wherein the identifying of the one or more fuel pilferage events being done for each associated current status of the one or more vehicles and the one or more sensors installed in the one or more vehicles, wherein the current status comprises a running state of the one or more vehicles, a stoppage state of the one or more vehicles, a missing data state of the one or more sensors and wherein the identifying being done in real time.

12. The computer system as recited in claim 11, further comprising calculating, at the fuel pilferage detection system, a fuel confidence score to reduce one or more false positive pilferage detection events, wherein the fuel confidence score being calculated based on one or more parameters, and wherein the one or more parameters comprises auto-correlation score, drop rate, pre-rise, post-rise, immediate-pre rise, immediate-post rise, near-by-mileage, null count and extreme fluctuation.

13. The computer system as recited in claim 11, further comprising storing, at the fuel pilferage detection system, the first set of data, the second set of data, the one or more fuel pilferage events and a fuel confidence score and wherein the storing being done in real time.

14. The computer system as recited in claim 11, further comprising updating, at the fuel pilferage detection system, the first set of data, the second set of data, the one or more fuel pilferage events and a fuel confidence score and wherein the updating being done in real time.

15. The computer system as recited in claim 11, further comprising a feedback mechanism, at the fuel pilferage detection system, to improve a prediction accuracy of the one or more fuel pilferage events and wherein the feedback mechanism being performed in real time.

16. The computer system as recited in claim 11, wherein the one or more vehicles being categorized in the first category of the plurality of categories when one or more actual data points collected being zero within a fixed interval of time, wherein the one or more vehicles being categorized in the second category of the one or more vehicles when distance covered by the one or more vehicles being at most 500 in a fixed interval of time and when one or more actual data points being at most 500 in a fixed interval of time, wherein the fixed interval of time comprises last 7 days.

17. The computer system as recited in claim 11, wherein the one or more vehicles being categorized in the third category of the plurality of categories when a difference between a maximum fuel and minimum fuel of the one or more vehicles in a fixed interval of time being at most 370, when a distance covered by the one or more vehicles in a fixed interval of time being more than a minimum distance and when non-null zero data points being more than 1000 and wherein the fixed interval of time comprises of 7 days.

18. The computer system as recited in claim 11, wherein the one or more vehicles being categorized in the fourth category of the plurality of categories when null score calculated in real time being at least 20, wherein the one or more vehicles being categorized in the fifth category of the plurality of categories when a zero score calculated in real time being at least 10

19. The computer system as recited in claim 11, wherein the one or more vehicles being categorized in the sixth category of the plurality of categories when at least one of an autocorrelation score being less than 40 percent and an extreme fluctuating score being more than 5 percent for 50 litres and 8 percent of 30 litres.

20. A computer-readable storage medium encoding computer executable instructions that, when executed by at least one processor, performs a method for real time dynamic and efficient detection of one or more fuel pilferage events in one or more vehicles, the one or more vehicles having one or more sensors, the method comprising:
receiving, at a computing device, a first set of data corresponding to fuel level values associated with one or more fuel sensors, wherein the first set of data being received from the one or more fuel sensors in real time and wherein the one or more fuel sensors being installed in the one or more vehicles;
collecting, at the computing device, a second set of data associated with a real time position of the one or more vehicles travelling from one point to another, wherein the second set of data being collected from one or more geo-location sensors in real time and wherein the one or more geo-location sensors being installed in the one or more vehicles;
analyzing, at the computing device, the first set of data and the second set of data, wherein the analyzing being done to identify a position of the one or more vehicles, time and a current working status of the one or more fuel sensors based on real time fuel level values in real time;
categorizing, at the computing device, the one or more vehicles in a plurality of categories based on the analysis of the first set of data and the second set of data, wherein the plurality of categories comprises a first category of vehicles having one or more sensors not being installed, a second category of vehicles having one or more sensors with insufficient data for categorization, a third category of vehicles having one or more non-calibrated sensors, a fourth category of vehicles having one or more null dropping sensors, a fifth category of sensors having one or more zero dropping sensors, a sixth category of vehicles having one or more fluctuating sensors and a seventh category of vehicles having one or more working sensors and wherein the categorizing being done in real time; and
identifying, at the computing device, the one or more fuel pilferage events in the one or more vehicles based on the analysis of the first set of data and the second set of data, wherein the identifying being done by utilizing a fuel pilferage detection algorithm, wherein the identifying of the one or more fuel pilferage events being done for each associated current status of the one or more vehicles and the one or more sensors installed in the one or more vehicles, wherein the current status comprises a running state of the one or more vehicles, a stoppage state of the one or more vehicles, a missing data state of the one or more sensors and wherein the identifying being done in real time.
